(19) United States
(12) Patent Application Publication
(10) Pub. No.: US 2008/0111837 A1
(43) Pub. Date: May 15, 2008

(54) Driving method of a display

(76) Inventors: Do-ki Kim, Suwon-si (KR); Do-hyung Ryu, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/826,096

(22) Filed: Jul. 12, 2007

(30) Foreign Application Priority Data
Nov. 9, 2006 (KR) 10-2006-0110571

(51) Int. Cl. G09G 5/10

(52) U.S. Cl. 345/690; 345/204

(57) ABSTRACT

A method for driving a display may include sequentially supplying a first scan signal to odd numbered scan lines, and sequentially supplying a second scan signal to even numbered scan lines to display one frame of an image, wherein the first and second scan signals are offset from one another by a fraction of a frame period.

### BACKGROUND OF THE INVENTION

1. Field of the Invention

Embodiments of the present invention relate to a driving method of a display. More particularly, embodiments relate to a method for digitally driving a display.

2. Description of the Related Art

Recently, various flat panel displays having reduced weight and volume compared with cathode ray tubes (CRTs) have been developed. Flat panel displays include liquid crystal displays (LCDs), field emission displays (FEDs), plasma display panels (PDPs), and organic light emitting displays.

Organic light emitting displays make use of organic light emitting diodes (OLEDs) that emit light by re-combination of electrons and holes. The organic light emitting display has advantages of high response speed and small power consumption.

A pixel of a conventional organic light emitting display may include an OLED and a pixel circuit, coupled to a data line Dm and a scan line Sn, to control the OLED, i.e., the OLED may generate light of a predetermined luminance corresponding to an electric current from the pixel circuit.

When a scan signal is supplied to the scan line, the pixel circuit may control an amount of an electric current provided to the OLED corresponding to a data signal provided to the data line Dm. To achieve this, the pixel circuit may include a transistor and a storage capacitor. The transistor may be coupled between a first power supply and the OLED. The OLED may be between a second power supply and the pixel circuit. The transistor may control an amount of an electric current flowing from the first power supply ELVDD to the second power supply ELVSS through the OLED according to the voltage stored in the storage capacitor. However, because pixels of the conventional organic light emitting display express gradations using a voltage stored in the storage capacitor, exact expression of desired gradations may be difficult. In practice, using an analog drive, the pixels should express a plurality of gradations using a constant voltage to be stored in the storage capacitor. Thus, in the conventional organic light emitting display, accurate brightness difference between adjacent gradations may not be expressed.

Further, in the conventional organic light emitting display, threshold voltage and electron mobility of the transistor may vary between pixels due to a process deviation. When deviations of the threshold voltage and electron mobility in the transistor occur, each pixel may generate light of different gradations in response to the same gradation voltage. Thus, the conventional organic light emitting display may not display an image of uniform luminance.

### SUMMARY OF THE INVENTION

Embodiments of the present invention are therefore directed to a method for driving a display, which substantially overcomes one or more of the problems due to the limitations and disadvantages of the related art.

It is a feature of an embodiment of the present invention to provide a method for digitally driving a display having a reduced or eliminated flicker.

It is another feature of an embodiment of the present invention to provide a method for digitally driving a display having a reduced or false contour.

It is yet another feature of an embodiment of the present invention to provide a method for digitally driving a display using spatial averaging effect between adjacent lines being driven by scan signals offset by a fraction of a frame period.

At least one of the above and other features and advantages of the present invention may be realized by providing a method for driving a display, including sequentially supplying a first scan signal to odd numbered scan lines and sequentially supplying a second scan signal to even numbered scan lines to display one frame of an image, wherein the first and second scan signals are offset from one another by a fraction of a frame period.

The one frame may be divided to display grey levels of each pixel. The one frame may include a plurality of subframes (SF1, SF2, . . . , SFn), each subframe corresponding to n bits of a data signal. The plurality of subframes may include eight subframes (SF1, SF2, . . . , SF8). Each of the subframes may be selected by each of the bits of the input data signal, the selected subframes emitting light. One frame may be sequentially turned on in order of an nth subframe (SFn), a first subframe (SF1), . . . , an n-1st subframe (SFn-1) through the even numbered scan line adjacent to the odd numbered scan lines if one frame is sequentially turned on in order of a first subframe (SF1), a second subframe (SF2), . . . , an nth subframe (SFn) through the odd numbered scan lines.

First scan signals supplied to subsequent odd numbered lines may be shifted by another fraction relative to previous first scan signals. Second scan signals supplied to subsequent even numbered lines may be shifted by the another fraction relative to previous second scan signals. The another fraction may be smaller than the fraction.

The fraction of the frame period may be one-half. The fraction may remain constant between first and second scan signals throughout the sequential supplying. The display may be an organic light emitting display.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates an organic light emitting display according to an embodiment of the present invention;

FIG. 2 illustrates one frame in a method for driving an organic light emitting display according to an embodiment of the present invention;

FIG. 3 illustrates an occurrence of pseudo contour noise during a digital drive;

FIG. 4 illustrates one frame in a method for driving a display according to an embodiment of the present invention; and

FIG. 5 illustrates minimized pseudo contour noise using the driving method of FIG. 4.

### DETAILED DESCRIPTION OF THE INVENTION

Korean Patent Application No. 10-2006-0110571, filed on Nov. 9, 2006, in the Korean Intellectual Property Office, and entitled: “Driving Method of Organic Light Emitting Display Device,” is incorporated by reference herein in its entirety.

Embodiments of the present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

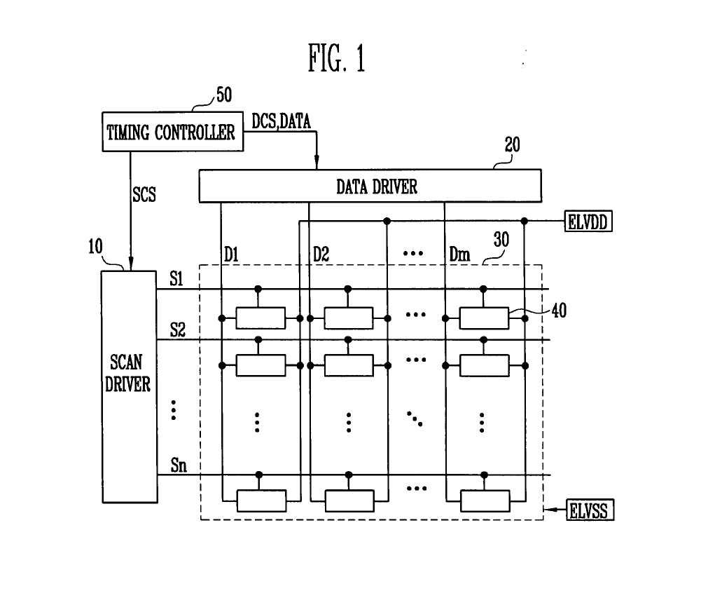

Hereinafter, example embodiments according to the present invention will be described with reference to the accompanying drawings, namely, FIG. 1 to FIG. 5. When one element is connected to another element one element may be not only directly connected to another element, but also may be indirectly connected to another element via another element. Further, irrelevant elements may be omitted for clarity. Also, like reference numerals refer to like elements throughout.

FIG. 1 illustrates an organic light emitting display according to an embodiment of the present invention

With reference to FIG. 1, the organic light emitting display according to an embodiment of the present invention may include a pixel portion 30 having pixels 40, a scan driver 10, a data driver 20, and a timing control unit 50. The pixels 40 may be connected to scan lines S1 through Sn and data lines D1 through Dm. The scan driver 10 may drive the scan lines S1 through Sn. The data driver 20 may drive the data lines D1 through Dm. The timing control unit 50 may control the scan driver 10 and the data driver 20.

The timing control unit 50 may generate a data driving signal DCS and a scan driving signal SCS corresponding to externally supplied synchronizing signals. The data driving signal DCS generated from the timing control part 50 may be provided to the data driver 20, and the scan driving signal SCS may be provided to the scan driver 10. Further, the timing control unit 50 may provide an externally supplied data DATA to the data driver 20.

The data driver 20 may supply a data signal to data lines D1 to Dm to every subframe time period of a plurality of subframe time periods included in one frame. The data signal may include a first data signal for a pixel 40 to emit light and a second data signal for a pixel 40 to not emit light. In other words, the data driver 20 may supply a first data signal or a second data signal, controlling emission or non-emission of the pixel 40, to data lines D1 to Dm every subframe time period.

The scan driver 10 may sequentially provide a scan signal to scan lines S1 to Sn every subframe period. When the scan signal is sequentially provided to the scan lines S1 to Sn, the pixels 40 are sequentially selected by lines, and the selected pixels 40 may receive the first data signal or the second data signal from the data lines D1 to Dm.

The pixel portion 30 may receive power of the first power supply ELVDD and power of the second power supply ELVSS from the exterior, and may supply power to the pixels 40. After the pixels 40 receive the power of the first power supply ELVDD and the power of the second power supply ELVSS, when the scan signal is supplied, the pixels 40 may receive a data signal (the first data signal or the second data signal), and emit light or not according to the data signal. For example, when the scan signal is supplied, the pixels 40 having received the first data signal emit light during a corresponding subframe period. In contrast to this, when the scan signal is supplied, the pixels 40 having received the second data signal do not emit light during a corresponding subframe period. Of course, opposite logic may be used in accordance with a structure of the circuit controlling the pixels 40.

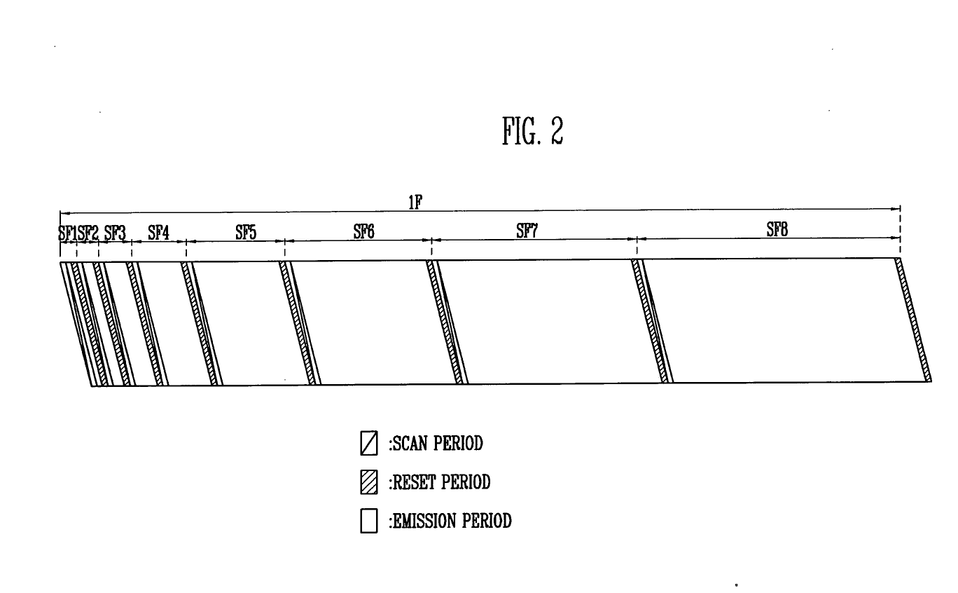

FIG. 2 illustrates a method for driving one frame in an organic light emitting display according to an embodiment of the present invention.

With reference to FIG. 2, one frame 1F may be divided into a plurality of subframes SF1˜SF8 to be driven by digital drive. Here, the respective subframes SF1˜SF8 may be divided into a scan period to sequentially supply a scan signal, an emission period to cause pixels 40 having received the first data signal during the scan period to emit light, and a reset period to cause the pixels 40 to be changed into a non-emission state.

During the scan period, the scan signal may be sequentially provided to the scan lines S1 to Sn. Also during the scan period, the first data signal or the second data signal may be supplied to respective data lines D1 to Dm. That is, the pixels 40 may receive the first data signal or the second data signal.

The pixels 40 emit light or not during the emission period while maintaining the first data signal or the second data signal supplied during the scan period. That is, the pixels 40 having received the first data signal during the scan period are set in an emission state during a corresponding subframe period, while the pixels 40 having received the second data signal are set in a non-emission state during a corresponding subframe period.

Different emission periods may be set according to respective subframes.

For example, in order to display an image with 256 gradations, as shown in FIG. 2, one frame may be divided into eight subframes SF1˜SF8. Further, the emission period of respective subframes SF1 to SF8 may be increased at the rate of 2ⁿ(n=0, 1, 2, 3, 4, 5, 6, 7) in the period. Namely, embodiments of the present invention may control emission or non-emission of pixels 40 based on respective subframes to display an image of a predetermined gradation. In other words, embodiments of the present invention may express a predetermined gradation during one frame period using a sum of emission times by the pixels 40 during the subframe periods.

The one frame illustrated in FIG. 2 is merely one example of frames with which embodiments of the present invention may be employed. Thus, the present invention is not limited thereto. For example, one frame maybe divided into more than ten subframes, and an emission period of each subframe may be variously set by a designer.

During the reset period, the pixels 40 may be set to a non-emission state. Additional wirings and transistors may be further included in each of the pixels 40 to achieve this reset state. Alternatively, the reset period may be eliminated.

Since the aforementioned digital drive expresses gradations using a turning-on or turning-off state of a transistor, an image of uniform luminance may be displayed. Furthermore, because embodiments express gradations using a time division, i.e., a digital drive, more exact gradations may be expressed as compared with expressing gradations using a constant voltage range, i.e., an analog drive.

However, even in the digital drive, since an emission time difference between a most significant bit and lower bits is typically large, a pseudo contour noise may occur. In other words, to express a gradation of 127, light may be emitted during the first to seventh subframes SF1 to SF7, and not emitted during the eighth subframe SF8. In order to express a gradation of 128, light may not be emitted during the first to seventh subframes SF1 to SF7, and may be emitted during the eighth subframe SF8. That is, in a digital drive, a predetermined time difference occurs upon expressing a specific gradation. The time difference may cause a pseudo contour noise to occur.

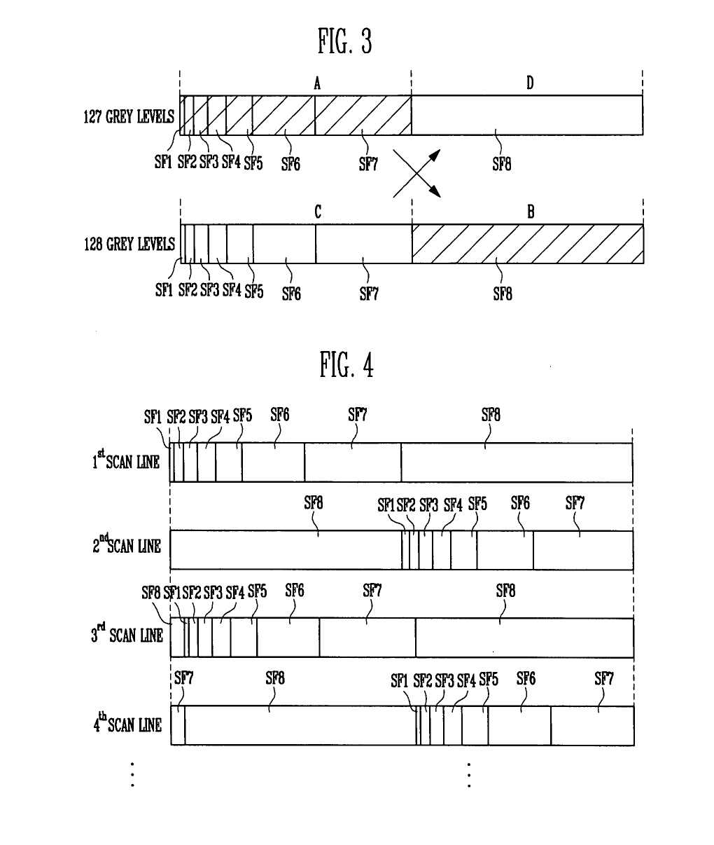

In detail, as shown in FIG. 3, a region “A” expressing a gradation of 127 and a region “B” expressing a gradation of 128 adjacent thereto will appear as a gradation of 255. Further, a region “C” expressing a gradation of 128 and a region “D” expressing a gradation of 127 adjacent thereto will appear as a gradation of zero. Such a pseudo contour noise is a main factor deteriorating display quality in a digital drive.

Furthermore, during a scan period of a subframe, a scan signal may be sequentially supplied to all the scan lines S1 to Sn. Because the supply period of the scan signal to the scan lines S1 to Sn does not contribute to emission, an emission time of the pixels 40 is shortened. In other words, when one frame includes eight subframes, a scan signal may be supplied to respective scan lines S1 to Sn eight times, shortening emission time.

In order to address the problem of the dynamic false contour, the number of subframes may be increased to drive a display device, but the increase in the number of the subframes increases driving frequency.

In order to solve the aforementioned disadvantages, an embodiment of the present invention may employ spatial averaging between adjacent lines, e.g., odd numbered scan lines and their adjacent even numbered scan lines. The adjacent lines may be driven with a non-progressive scan system, e.g., an interlaced scan system, in which scan signals applied to adjacent lines may be offset by a fraction, e.g., ½, of a frame period.

FIG. 4 illustrates one frame in a method for driving a display, e.g., an organic light emitting display, according to an embodiment of the present invention. While FIG. 4 illustrates one frame being divided into eight subframes, the present invention is not limited thereto.

Referring to FIG. 4, according to an embodiment of the present invention, a method for driving a display may reduce or eliminate flicker and/or false contour by a spatial averaging effect between adjacent lines by driving adjacent lines with signals having a time difference of a fraction, e.g., ½, of a frame period therebetween. For example, such offset signals may be supplied to odd numbered scan lines and adjacent even numbered scan lines in an interlace system, in which one frame of a picture is scanned twice, for example, by sequentially supplying a scan signal to the odd numbered scan lines and sequentially supplying a scan signal to the even numbered scan lines.

Each of the subframes (SF1˜SF8) constituting one frame may correspond to each bit of the data signal, wherein the least significant bit (LSB) corresponds to a first subframe (SF1), and the most significant bit (MSB) corresponds to an eighth subframe (SF8). For example, a pixel may emit light during a corresponding subframe period when receiving a first data signal, e.g., “1”, and may not emit light when receiving a second data signal, e.g., “0”.

For example, when a pixel is to display an image with 256 grey levels, one frame may be divided into eight subframes (SF1 to SF8), and a light emission period may be increased at a rate of 2ⁿ(n=0,1,2,3,4,5,6,7) in each of the eight subframes (SF1 to SF8). Thus, the pixels may display a predetermined grey level of an image by controlling whether or not individual pixels 40 emit light in each of the subframes (SF1˜SF8). Each pixel 40 may display a predetermined grey level of an image during one frame period using the sum of the emission time of that pixel during the subframe periods.

The one frame may be generally sequentially turned on in order of the first subframe (SF1) to the eighth subframe (SF8). Therefore, certain subframes may be selected in order from the first subframe (SF1) to the eighth subframe (SF8) by the input digital data. Then, the selected subframes may be allowed to emit light, and the grey levels may be displayed in accordance with the sum of the emission time of the subframes.

For example, if a pixel is to display 127 grey levels, i.e., input data is “01111111”, then the pixel emits light during the first subframe (SF1) to a seventh subframe (SF7), but not during the eighth subframe (SF8). If a pixel is to display 128 grey levels, i.e., the input data is “10000000”, then the pixel does not emit light during the first subframe (SF1) to the seventh subframe (SF7), but does emit light during the eighth subframe (SF8). Accordingly, the dynamic false contour, as shown above in FIG. 3, may be caused if a pixel displaying 127 grey levels is adjacent to a pixel displaying 128 grey levels.

Thus, an embodiment of the present invention may reduce or eliminate flicker and/or false contour by a spatial averaging effect between adjacent lines being driven at a time difference of a fraction, e.g., ½, of a frame period in a drive timing between odd numbered scan lines and their adjacent even numbered scan lines in the interlace driving system.

In accordance with an embodiment, one frame may be sequentially turned on in order of SF1, SF2, . . . , SF8 for a first scan line (an odd numbered scan line), while being sequentially turned on in order of SF8, SF1, . . . , SF7, e.g., may be shifted by ½ a frame period relative to the first scan line, for a second scan line (an even numbered scan line) adjacent to the first scan line.

Further, data of one frame may be displayed while being shifted at a predetermined time in subsequent odd numbered scan lines (3, 5, . . . , 2ⁿ-1), as shown in FIG. 4. For example, the predetermined time may correspond to an amount of time required to provide a signal to the final odd numbered 2ⁿ-1^{st} scan line or at an interval of every x scan line identical to that of the first scan line. Also, data of one frame may be displayed while being shifted at a predetermined time in subsequent even numbered scan lines (4, 6, . . . , 2ⁿ), as shown in FIG. 4, i.e., the time difference between subsequent adjacent odd and even scan lines may remain constant.

As a result, since the bits in each of the scan lines emit the light at a time difference, e.g., ½ a frame period, between the odd numbered scan lines and the even numbered scan lines in the above driving method, a region of more significant bits may emit light in predetermined scan lines when less significant bits emit light in adjacent scan lines, while less significant bits may emit the light in predetermined scan lines when more significant bits emit the light in adjacent scan lines. This may reduce or eliminate dynamic false contour and/or flicker, since the spatially adjacent scan lines are averaged together.

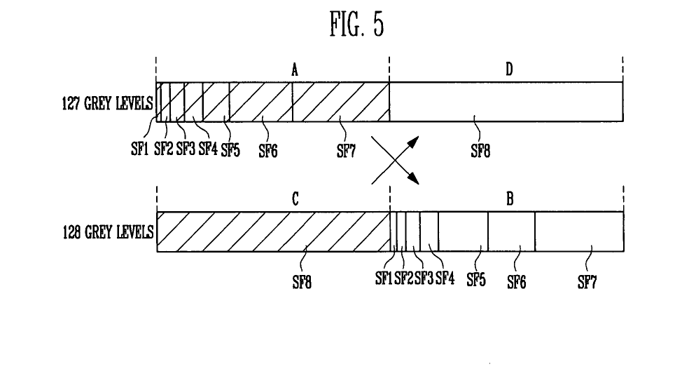

FIG. 5 illustrates how dynamic false contour may be reduced or eliminated in accordance with the driving method of FIG. 4.

FIG. 5 illustrates that the line of vision moves between a first pixel displaying 127 grey levels (an odd numbered line) and a second pixel displaying 128 grey levels (an even numbered line), and a dynamic false contour, caused by a time difference in light emission of the MSB and less significant bits, may be compensated using the driving method.

For example, if a first pixel of the odd numbered line is to display 127 grey levels, i.e., input data is “01111111”, then the first pixel emits light during the first subframe (SF1) to the seventh subframe (SF7), but not during the eighth subframe (SF8). If a second pixel of the even numbered line, adjacent to the odd numbered line, is to display 128 grey levels, i.e., input data is “10000000”, the second pixel emits light during the eighth subframe (SF8), but not during the first subframe (SF1) to the seventh subframe (SF7). In accordance with an embodiment, since one frame is sequentially realized by the second pixel in order of SF8, SF1, . . . , SF7, i.e., a second scan signal supplied to the second pixel is offset from a first scan signal supplied to the first pixel by ½ a frame period, false contour may be reduced or eliminated.

In other words, even when two grey levels have opposite values of “0” and “1” in each of the bits, and therefore pixels displaying the two grey levels respectively alternate an emission time and a non-emission time, the dynamic false contour may be reduced or prevented since scan signals supplied to drive adjacent pixels are offset, e.g., by a time difference of ½ a frame period.

More particularly, the region “B” will appear as 0 grey levels when the region “A” displays 127 grey levels and the region “B” displays 0 grey levels, as shown in FIG. 5. Also, the region “D” will appear as 128 grey levels when the region “C” displays 128 grey levels and the region “D” displays 0 grey levels.

Thus, display quality may be maintained using the digital driving method illustrated in FIG. 4 even when displaying a quickly moving image.

Accordingly, a display being driven in accordance with an embodiment described above may reduce or eliminate flicker and/or false contour by a spatial averaging effect between adjacent lines being driven by signals offset from one another, e.g., by a difference of ½ frame period.

Also, digital driving method of an embodiment may reduce or eliminate false contour and/or flicker without an increase in the number of subframes, which may allow power consumption to be lowered, and may be implemented easily by changing a driving order, e.g., without installation of additional external parts.

Exemplary embodiments of the present invention have been disclosed herein, and although specific terms are employed, they are used and are to be interpreted in a generic and descriptive sense only and not for purpose of limitation. For example, while the subframes illustrated form a geometric series, embodiments may be used with other subframe arrangements. A fractional offset may be adjusted in accordance with the subframe arrangement. Accordingly, it will be understood by those of ordinary skill in the art that various changes in form and details may be made without departing from the spirit and scope of the present invention as set forth in the following claims.

What is claimed is:

1. A method for driving a display, comprising;
sequentially supplying a first scan signal to odd numbered scan lines; and
sequentially supplying a second scan signal to even numbered scan lines to display one frame of an image, wherein the first and second scan signals are offset from one another by a fraction of a frame period.

2. The method as claimed in claim 1, further comprising dividing the one frame to display grey levels of each pixel.

3. The method as claimed in claim 2, wherein the one frame includes a plurality of subframes (SF1, SF2, . . . , SFn), each subframe corresponding to n bits of a data signal.

4. The method as claimed in claim 3, wherein a plurality of subframes include eight subframes (SF1, SF2, . . . , SF8).

5. The method as claimed in claim 3, wherein each of the subframes is selected by each of the bits of the input data signal, the selected subframes emitting light.

6. The method as claimed in claim 3, wherein one frame is sequentially turned on in order of an nth subframe (SFn), a first subframe (SF1), . . . , an n-1st subframe (SFn-1) through the even numbered scan line adjacent to the odd numbered scan lines if one frame is sequentially turned on in order of a first subframe (SF1), a second subframe (SF2), . . . , an nth subframe (SFn) through the odd numbered scan lines.

7. The method as claimed in claim 1, wherein the fraction of the frame period is one-half.

8. The method as claimed in claim 1, wherein first scan signals supplied to subsequent odd numbered lines are shifted by another fraction relative to previous first scan signals.

9. The method as claimed in claim 8, wherein second scan signals supplied to subsequent even numbered lines are shifted by the another fraction relative to previous second scan signals.

10. The method as claimed in claim 8, wherein the another fraction is smaller than the fraction.

11. The method as claimed in claim 1, wherein the fraction remains constant between first and second scan signals throughout the sequential supplying.

12. The method as claimed in claim 1, wherein the display is an organic light emitting display.
